(19) United States
(12) Patent Application Publication
(10) Pub. No.: US 2015/0052789 A1
(43) Pub. Date: Feb. 26, 2015

(54) Greeting Insert System

(71) Applicant: Susan Elisabeth Lein, Los Angeles, CA (US)

(72) Inventor: Susan Elisabeth Lein, Los Angeles, CA (US)

(21) Appl. No.: 14/464,615

(22) Filed: Aug. 20, 2014

Related U.S. Application Data
(60) Provisional application No. 61/867,724, filed on Aug. 20, 2013.

(51) Int. Cl. B42D 15/04

(52) U.S. Cl. CPC B42D 15/045; B42D 15/042
USPC 40/124.09; 40/124.01

(57) ABSTRACT

A greeting insert system that permits the self-selection of specific greetings to commemorate special occasions. The system enables the mixing and matching of various card jackets with distinct and separate greeting inserts to offer a wide variety of options for finished greeting cards. Alternatively, a greeting insert system may be utilized with commercially available blank card jackets of the end users choice.

### TECHNICAL FIELD

A greeting insert system that facilitates the transformation of a blank card jacket into a customized greeting that acknowledges a specific event or situation. In certain embodiments, the greeting insert system permits the selection and inclusion of a desired common greeting into a non-descript card jacket thereby enabling someone to acknowledge a special or notable occasion, a life event, or a specific purpose with a customized card.

### BACKGROUND

Decorative or fanciful greeting cards are often utilized to extend greetings, thoughts or wishes to another person on special occasion or holidays, For example birthdays, graduations and certain holidays are just a few examples where cards are often purchased and delivered by an individual to acknowledge another person. Often times, the selection of a specific card or the task of traveling to a store to select a greeting specific card can be at the least time consuming or even difficult. Blank greeting cards can serve as functional replacements when time or travel is too burdensome to select and purchase a greeting specific card. However, blank cards can be impersonal or they lack artwork, statements or poems in desirable formats that often make the card meaningful to either the person extending the greeting, the person receiving the card, or both.

The number of specific holidays, special occasions and events often require retailers of greeting cards to maintain substantial inventories to address so many different and distinct events. Individuals searching for just the right card can be very selective and potentially dissatisfied with a vendors inventory. This potentially leads to unhappy consumers, a non-purchase by the consumer, or an event that may deliberately go unacknowledged.

### SUMMARY

This disclosure is directed to a greeting insert system that permits the self-selection of specific greetings to commemorate special occasions. In certain embodiments, the system of this disclosure allows the transformation of a blank card, which could be used in and of itself, into a more complex and tailored product. In certain embodiments, a greeting card insert system may include properly sized and prepared inserts with a specific commercially printed greeting to acknowledge common occasion or events. The greeting may include a folded paper containing a desirable greeting that is appropriately sized. The greeting insert readily be readily placed inside the card jacket and retained by the fastener. The fastener functions as a retaining element and in some embodiments may be decorative as well, providing significant enhancement to the card jacket The system is non permanent, easily and efficiently set up, and does not require tools or adhesives.

By de-coupling the card jacket and the greeting insert, the greeting insert system of this disclosure ensures that inventory management, size and costs for the merchant are reduced and the consumer is able to enhance their own ability to create customized greeting in a more efficient manner.

In one embodiment, the greeting insert system includes a pre-printed greeting produced on presized and folded paper and a fastener that facilitates the securing of the greeting insert while still allowing the functional mobility of the card jacket to remain intact. The flexibility of the fastener is obtained either inherently in its material composition, such as for example, any elastomeric material.

The greeting insert system may be marketed as solely the greeting insert and the fastener for retaining the greeting insert into any commercially available card jacket. In another alternative embodiment, the greeting card insert system can include a card jacket or a plurality of card jackets with a plurality of greeting inserts to enable the end user to efficiently select and tailor a desired greeting for a given occasion. The ability to select a specific greeting insert with a card jacket enables customization for desired occasions and events. The greeting insert is generally affixed through a quick and tool-free assembly mechanism.

The customization of greeting cards contemplated by this disclosure are distinct and different from personalized cards that may be designed by the user and readily printed from various internet sites or software programs. The customization of greeting cards renders multiple uses for general stock items thereby enabling the ability to mix and match various card jackets, including commercially available card jackets, with an array of greeting inserts. The system of this disclosure renders an efficient and cost effective approach to create desirable greeting cards.

The greeting insert system of this disclosure enables the end user to easily customize a variety of greeting card jackets with specific greetings or fanciful art created onto greeting inserts. The system requires no tools or complicated and messy adhesives to create a final greeting card. An individual may spontaneously and efficiently create a desirable greeting card with extensive array of options giving them a large degree of freedom.

The greeting insert system enables retailers to minimize or significantly reduce greeting card inventories while providing a full range of greeting card options and possibilities. In certain embodiments, the card jackets generally may be without verbiage, written content, or fanciful art on internal portions of the card jacket, thereby enabling their use in a multitude of occasions and events.

Certain terms used in this application are defined as follows:

“card jacket” means a medium that functions as the outer portion of a booklet style greeting card that covers or protects any internal contents or pages, such as a greeting insert;

“fastener” means a string, cord, strip or band of a material that possesses at least some level of elasticity, the fasteners not in a continuous loop may be knotted, tied, or secured into a continuous loop with a clasp or mechanical connecting device.

“greeting insert system” means a prepared greeting insert designed to meet, match or enhance specific card jacket shapes and a fastener for removably affixing or retaining the greeting insert in the card jacket and thereby creating a customized greeting card; and

“greeting insert” means a separate and distinct medium that may be inserted and affixed to any card jacket, the medium may include customized greetings, indicia or fanciful art.

The above summary is not intended to describe each disclosed embodiment or every implementation. The detailed description that follows more particularly exemplifies illustrative embodiments.

### DESCRIPTION OF THE DRAWINGS

FIG. 1 is an exploded view of one embodiment contemplated by this disclosure; and

FIG. 2 is a illustration of the same embodiment of FIG.1 with all elements in direct connection.

### DETAILED DESCRIPTION

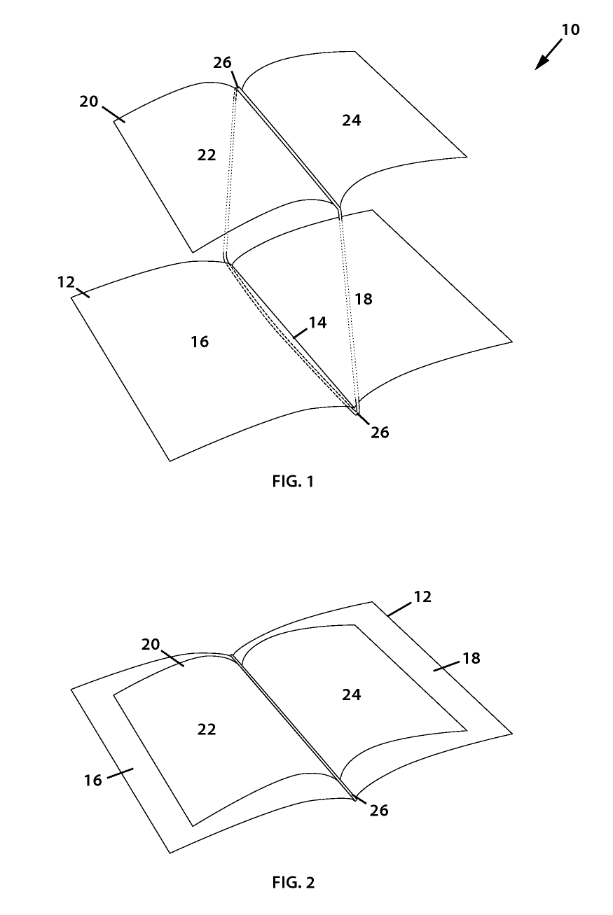

FIG. 1 and FIG. 2 are illustrative of one embodiment of a customized greeting insert system 10 of this disclosure. The greeting insert system 10 includes a card jacket 12 partitioned by a fold line 14. The fold 14 functions as a hinge for the opening and closing of the card jacket 12. The partitioning of the card jacket 12 with fold 14 results in a booklet appearance. The inner pages 16, 18 of the card jacket 12 may be utilized to place or extend specific greetings. A greeting insert 20 is removably affixed internal of the card jacket 12. The greeting insert 20 is positioned proximate to the fold 14 to form a booklet having pages 22, 24. In this embodiment, the greeting insert 20 is held in place and retained in the card jacket 12 by a fastener 26. Fanciful art or other indicia (not shown) may be placed on the card jacket 12, the internal portions of the card jacket 16, 18, the greeting insert 20 on one of more pages 22, 24.

The card jacket includes any medium suitable for serving as the outer portion of the greeting card and capable of receiving a greeting insert. The card jacket may be sectioned about a fold to create a partitioned card jacket. The fold permits the card jacket to rotate about the fold to create an internal section of the card jacket. In other embodiments, multiple card jackets may be bonded together to create a hinged booklet. The card jacket may take various geometric forms. Examples of non-limiting shapes may include rectangles, squares, trapezoids, polygons, or various other shapes or sizes. Dimensions of the card jacket may vary, but they are generally commercially reasonable sizes. In certain embodiments, the card jackets may be conventionally recognized dimensions for greeting cards, such as for example, about 5.5 inches high by about 4 inches wide.

The internal portion of the card jacket, the external portion of the card jacket or both may be blank with respect to verbiage or written information. The non-descript nature of the card jackets enables the broad application of the card jacket with a desired greeting insert. In certain embodiments, the card jacket may be a conventional, commercially available blank card from various manufacturers or suppliers. Additionally, the card jacket may include non-descript fanciful art or indicia that can be interpreted as generic to a multitude of occasions.

The greeting insert may include any medium that is capable of serving as an insertable segment into the card jacket. The greeting insert may be placed, segmented, partitioned or folded to fit into the card jacket to create pages within the card jacket. This enables the proper placement and assures functionality of the greeting insert in the card jacket. In certain embodiments, the greeting insert is removably affixed in the internal section of the card jacket proximate to the fold. The greeting insert may take various geometric forms that may or may not replicate or mirror the form of the card jacket. Examples of non-limiting shapes may include rectangles, squares, trapezoids, polygons, or various shapes or sizes. Those of ordinary skill in the art with knowledge of this disclosure are capable of selecting appropriate forms and dimensions of a greeting insert and matching it with card jacket to create the greeting card system.

The greeting insert is removably affixed into the card jacket. This approach creates the ability to select and match different card jacket designs with a desirable greeting insert. Essentially, the end user can pick and choose different elements to create a wide array of finished greeting cards. The stated approach can be addressed at either the point of purchase or by an individual at home with a set of differing card jackets and greeting inserts or commercially available blank card jackets with greeting inserts.

The greeting insert is removably affixed by various fasteners that enable a quick, tool-free assembly. A fastener is any string, cord, strip or band of a material that possesses at least some level of elasticity. In some embodiments, the fasteners that are not generally provided in a continuous loop may be knotted, tied, or secured into a continuous loop with a clasp or mechanical connecting device. Those of ordinary skill in the art with knowledge of this disclosure may recognize that any woven, braided, or knitted construction of an elastomeric material may be suitable for use as a fastener. Additionally materials of construction of the fastener may. Non-limiting examples include cotton, polyester, rayon or nylon material.

Generally, the fasteners are adjustable such that the end user can easily affix the insert into the card jacket without adversely affecting the integrity or look of the card jacket. In certain embodiments, a greeting insert is retained in a card jacket by a fastener that adds aesthetic appeal or features to the greeting insert system. In alternative embodiments where a fastener may be knotted tied or secured into a continuous loop, clasp or other mechanical connections such as fanciful beads or clips can provide the necessary loop closing function. The fasteners may include indicia or fanciful art to add to the aesthetics of the greeting insert system.

The flexible characteristics of the fastener enable it to be made sufficiently large so as to encircle the card jacket that the greeting insert is designed to fit. Then, either by release or through the process of minor adjustments by securing a clasp or mechanical connecting device, the fastener contracts so as to provide sufficient security and enable the greeting to swing concurrently with the card jacket as it is opened and closed.

In some embodiments, fasteners are provided as separate articles in the greeting insert system. The end user of the greeting insert system is then capable of applying a selected greeting insert with a desired fastener to transform a card jacket into a more complex and tailored product.

In certain embodiments, the card jacket or the greeting insert are made from the materials selected from paper, recycled paper, polymeric substrates, linen, natural fibers or combinations thereof. Those of ordinary skill in the art with knowledge of this disclosure are capable of selecting a specific medium based upon the desired appearance, the size or shape of the greeting card, or the selected fanciful art or indicia.

Certain embodiments will employ a wide variety and array of indicia or fanciful art. Non-limiting examples of indicia include graphics, poems, text, markings or combinations thereof. Non-limiting examples of fanciful art include pictures, water color art, artwork, graphic designs or combinations thereof. Replicated drawings or prints of original art work are also contemplated by this disclosure.

The customized greeting card created by the greeting insert system of this disclosure can be used to commemorate various events, holidays, or special occasions or simply as offerings and well wishes from individual to another. An individual may spontaneously and efficiently create a desirable greeting card with extensive array of options giving them a large degree of freedom.

In one embodiment, a complete system of greeting cards can be established with a plurality of card jackets and greeting inserts. The system enables the selection of separate and distinct card jackets with a different greeting inserts to create unique and different greeting cards. In another embodiment, a system or kit with various greeting inserts and a retaining mechanism such as an elastomeric band, may be offered commercially to mix and match with commercially available blank or non-descript card jackets of the end users choice. Vendors employing any of the greeting card systems of this disclosure can rely upon a wide variety of selective options for the consumer without carrying substantial inventories to address a wide array of occasions, holidays or events. End users can purchase variations of the greeting card system for home use to enjoy timely options, conveniences and efficiencies enabled by the creative opportunities afforded by the greeting card insert system.

From the above disclosure of the general principles of the present invention and the preceding detailed description, those skilled in this art will readily comprehend the various modifications to which the present invention is susceptible. Therefore, the scope of the invention should be limited only by the following claims and equivalents thereof.

What is claimed is:

1. A greeting insert system comprising (i) a plurality of greeting inserts, and (ii) a plurality of fasteners, wherein the greeting inserts include indicia or fanciful art and wherein each greeting insert is capable of being removably affixed internal to a card jacket by each fastener to form a customized greeting card.

2. The greeting insert system of claim 1, wherein the card jacket is a commercially available card jacket having an internal portion that is blank.

3. The greeting insert system of claim 1, wherein the greeting insert is affixed about a fold of the card jacket.

4. An article comprising,
(a) card jacket that is sectioned by a fold, wherein the fold permits the card jacket to rotate about the fold to create an internal section of the card jacket, and
(b) at least one greeting insert removably affixed in the internal section of the card jacket proximate to the fold, wherein the greeting insert includes indicia or fanciful art.

5. The article of claim 4, wherein the greeting insert has a fold and the fold of the greeting insert is removably affixed about the fold of the card jacket by a fastener.

6. The article of claim 4, wherein the indicia includes graphics, poems, text, markings or combinations thereof.

7. The article of claim 4, wherein fanciful art includes pictures, water color art, artwork, graphic designs, or combinations thereof.

8. The article of claim 4, wherein the card jacket or the greeting insert are made from materials selected from paper, recycled paper, polymeric substrates, linen, natural fibers or combinations thereof.

9. A greeting insert kit comprising a greeting insert and a fastener, wherein the greeting inserts include indicia or fanciful art and wherein each greeting insert is capable of being removably affixed internal to a card jacket by the fastener to form a customized greeting card.

10. The greeting insert kit of claim 9, wherein the greeting insert has a fold and the fold of the greeting insert is removably affixed about the fold of the card jacket by a fastener.

11. The greeting insert kit of claim 9, wherein the indicia includes graphics, poems, text, markings or combinations thereof and the fanciful art includes pictures, water color art, artwork, graphic designs, or combinations thereof.

12. A greeting insert system comprising,
(a) a plurality of card jackets, each card jacket sectioned by a fold, wherein the fold permits the card jacket to form an internal segment, and
(b) a plurality of greeting inserts, each greeting insert capable of being removably affixed in the internal segment of each card jacket proximate to the fold, wherein the greeting insert includes indicia or fanciful art, and wherein the plurality of card jackets is interchangeable with the plurality of greeting inserts.

13. The greeting card system of claim 12, wherein the greeting insert has a fold and the fold of the greeting insert is removably affixed about the fold of the card jacket.

14. The greeting card system of claim 12, wherein the indicia includes graphics, poems, tests, markings or combinations thereof.

15. The greeting card system of claim 12, wherein fanciful art includes pictures, water color art, artwork, graphic designs, or combinations thereof.

16. The greeting card system of claim 12, wherein the plurality of card jackets or the plurality of greeting inserts are made from the materials selected from paper, recycled paper, polymeric substrates, linen, natural fibers or combinations thereof.
